(19) United States
(12) Patent Application Publication
(10) Pub. No.: US 2026/0086020 A1
(43) Pub. Date: Mar. 26, 2026

(54) CONTACTLESS THERMOGRAPHY BASED APPROACH FOR MEASURING THE RATE OF CORROSION UNDER INSULATION

(71) Applicant: Saudi Arabian Oil Company, Dhahran (SA)

(72) Inventors: Hamad Al Saiari, Al-Khobar (SA); Ali Alshehri, Thuwal (SA); Ayman Amer, Thuwal (SA); Ahmed Aljarro, Thuwal (SA)

(73) Assignee: Saudi Arabian Oil Company, Dhahran (SA)

(21) Appl. No.: 18/894,887

(22) Filed: Sep. 24, 2024

(51) Int. Cl. G01N 17/00; G06T 1/00; G06T 7/00

(52) U.S. Cl. CPC G01N 17/008; G01N 17/006; G06T 1/0007; G06T 7/0008; G06T 7/97; G06T 2207/10048; G06T 2207/20081; G06T 2207/20084; G06T 2207/30136

(57) ABSTRACT

A method of determining corrosion rate in a pipe surrounded using contactless thermography includes heating or cooling the structure and capturing a first, second and third thermal images of the structure at a respective initial time, after installation and when the pipe is entirely corroded. Corresponding heat flux values are derived from each thermal image. A ratio of the metal loss is determined as a ratio of the difference between the first heat flux and the second heat flux to a difference between the first heat flux and the third heat flux. A machine learning algorithm is trained to determine a level of corrosion in a metallic pipe structure, and a second machine learning algorithm is trained to a determine a level of deposits in a pipe structure. A corrected metal loss is determined by applying the algorithm output to the ratio of the metal loss.

### FIELD OF THE DISCLOSURE

The present invention relates to inspection technologies, and, more particularly, relates to a system and method for contactless thermography for measuring corrosion under insulation.

### BACKGROUND OF THE DISCLOSURE

Corrosion under insulation (CUI) is a condition in which an insulated structure such as a metal pipe suffers corrosion on the metal surface beneath the insulation. As the corrosion cannot be easily observed due to the insulation covering, which typically surrounds the entire structure, CUI is challenging to detect. There are a number of different causes of corrosion and other damage to pipes. FIG. 7 is a perspective view of a pipe section that illustrations examples of pipe corrosion which include due to moisture and oxidation, embrittlement due to stress and sulfide corrosion, hydrogen induced cracking (HIC), and flow-induced corrosion.

One of the more prevalent of these causes of CUI is moisture buildup that infiltrates into the insulation material. Water can accumulate in the annular space between the insulation and the metal surface, causing surface corrosion. Sources of water that can induce corrosion include rain, water leaks, and condensation, cooling water tower drift, deluge systems and steam tracing leaks. While corrosion usually begins locally, it can progress at high rates especially if there are repetitive thermal heating and/or cooling cycles or contaminants in the water medium or surrounding air such as chloride or acid.

Over time, these corrosive processes lead to metal loss in the pipe structure and can ultimately lead to severe pipe damage that requires remediation. The amount of metal loss remains unnoticed until insulation is removed or advanced NDT (non-destructive testing) techniques, such as infrared thermography, are used to ascertain the metal condition beneath the insulation. Removal of insulation can be a time-consuming and costly process, while the accuracy of NDT techniques can be insufficient due to the large number of variables (e.g., geometrical, environmental, material-related), that cause false positives (incorrect detection of corrosion) and false negatives (incorrect non-detection of corrosion) in the detection process. Additionally, many facilities have elevated networks of pipes that are difficult to access, requiring scaffolding for visual inspection.

Recently, automated non-invasive techniques for detecting structural corrosion have been developed. In one such technique, described in commonly-owned U.S. patent application Ser. No. 16/117,937, entitled “Cloud-Based Machine Learning System and Data Fusion for the Prediction of Corrosion Under Insulation,” infrared thermal imaging is used to detect corrosion. A thermal imaging device can be coupled to a robotic device that can cover large spans of infrastructure, dispensing with the need for manual inspection. Such techniques have provided data about rates of corrosion of different types of structures in a variety of situations.

In addition, machine learning has been applied more specifically to the problem of determining pipe metal loss. Commonly owned and assigned U.S. patent application Ser. No. 16/548,399 entitled “Localized metal loss estimation across piping structure” disclosed using historical data to train machine learning models to predict metal loss in pipe structures over time.

While these techniques have proven useful, they are costly in terms of the amount of computing resources that they require, and their accuracy, in certain cases, can be improved upon.

### SUMMARY OF THE DISCLOSURE

The present disclosure describes a method of determining corrosion rate in a thickness of a structure having a pipe surrounded by an insulator using contactless thermography. In at least one embodiment the method includes i) heating or cooling the structure and capturing a first thermal image of the structure at an initial time when the structure is installed, wherein a first heat flux (Q is derived from the first thermal image, ii) heating or cooling the structure and capturing a second thermal image of the structure at a time (t) after installation during use of the structure, wherein a second heat flux (Qₜ) is derived from the second thermal image, and iii) heating or cooling the structure and capturing a third thermal image of the structure with the pipe entirely corroded (Q_{infinity}). wherein a third heat flux (Q_{infinity}) is derived from the third thermal image. The method further comprises determining, to a first order of approximation, a ratio of the metal loss as a ratio of a difference between the first heat flux and the second heat flux to a difference between the first heat flux and the third heat flux (Q₀−Qₜ/Q₀−Q_{infinity}), training a first machine learning algorithm executing on a processor using thermal images and historical data to determine a level of corrosion in a metallic pipe structure, training a second machine learning algorithm executing on a processor using thermal images and historical data to determine a level of deposits in a pipe structure, executing the first machine learning algorithm to determine a corrective coefficient (C_{c}) based on a detected level of corrosion, executing the second machine learning algorithm to determine a correction coefficient (C_{d}) based on a detected level of deposits; and determining a corrected metal loss by applying the corrective coefficients (C_{c}, C_{d}) to the ratio of the metal loss to arrive at a final metal loss estimate. It will be appreciated that the first and second machine learning algorithms can execute on the same processor, a different processor (e.g., each executing on respective second and third processors), or a processor utilized in connection with other components of the system and method disclosed herein (e.g., the same processor used to determine the ratio of metal loss).

In another aspect, the present disclosure describes a system for determining material loss in a thickness of a structure having a pipe surrounded by an insulator using contactless thermography. The system comprises a thermal camera operable to capture thermal images of the structure, and to capture a first thermal image at time t₀ at which the structure is newly installed, a second image at time tₜ during operation of the structure and a third image when the pipe is entirely corroded (t_{infinity}). The system further includes a heating or cooling device positioned near the structure to cause local disturbance in a temperature of the structure operable to heat or cool the structure prior to the capture of each of the first, second and third thermal images, and a processor coupled to the thermal camera and operable to receive the first, second and third thermal images. The processor is configured to determine a first heat flux (Q₀) from the first thermal image, a second heat flux (Qₜ) is from the second thermal image, and a third heat flux (Q_{infinity}). from the third thermal image, determine, to a first order of approximation, a ratio of the metal loss as a ratio of a difference between the first heat flux and the second heat flux to a difference between the first heat flux and the third heat flux (Q₀−Qₜ/Q₀−Q_{infinity}), execute a first machine learning algorithm trained using thermal images and historical data to determine a level of corrosion in a metallic pipe structure to determine a corrective coefficient (C_{c}) based on a detected level of corrosion, execute a second machine learning algorithm trained using thermal images and historical data to determine a level of corrosion in a metallic pipe structure to determine a corrective coefficient (C_{d}) based on a detected level of metallic deposition, and determine a corrected metal loss by applying the corrective coefficients (C_{c}, C_{d}) to the ratio of the metal loss to arrive at a final metal loss estimate.

These and other aspects, features, and advantages can be appreciated from the following description of certain embodiments of the disclosure and the accompanying drawing figures and claims.

### BRIEF DESCRIPTION OF THE DRAWINGS

FIG. 1 is a schematic diagram of a system for obtaining contactless thermography measurements from a structure to determine corrosion-under installation within the structure according to an embodiment of the present disclosure.

FIG. 2 shows the same system as in FIG. 1 while illustrating an alternative testing procedure in which the heating/cooling device and thermal camera move around the pipe structure circumferentially.

FIG. 3 is a schematic flow diagram of an embodiment of a method of measuring metal loss using contactless thermography according to the present disclosure.

FIG. 4 is a flow chart of a method of determining corrosion rate according to an embodiment of the present disclosure.

FIG. 5 is a schematic diagram showing the effects of corrosion and deposition on pipe surfaces.

FIG. 6 is a schematic diagram that illustrates how distinct machine learning algorithms can be trained to determine the correction factors according to an embodiment of the present disclosure.

FIG. 7 is a perspective view of a pipe section that illustrations examples of pipe corrosion which include pitting due to moisture and oxidation, embrittlement due to stress and sulfide corrosion, hydrogen induced cracking (HIC), and flow-induced corrosion.

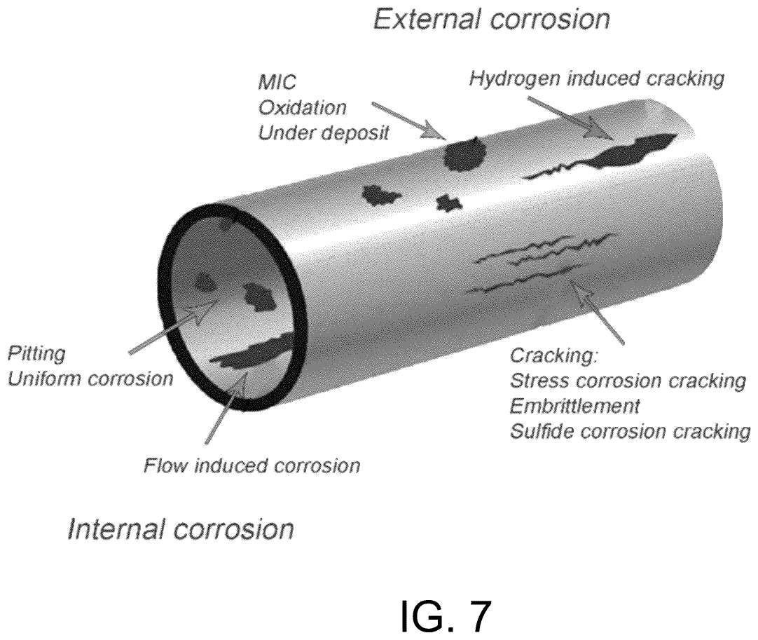

### DETAILED DESCRIPTION OF CERTAIN EMBODIMENTS CONSISTENT WITH THE DISCLOSURE

Embodiments of the disclosure provide a system and method determining corrosion rate in infrastructure using contactless thermography. One advantage of the system and method is that it rapidly provides a first order approximation of the metal loss, which is then corrected for signs of structural damage including corrosion and deposits.

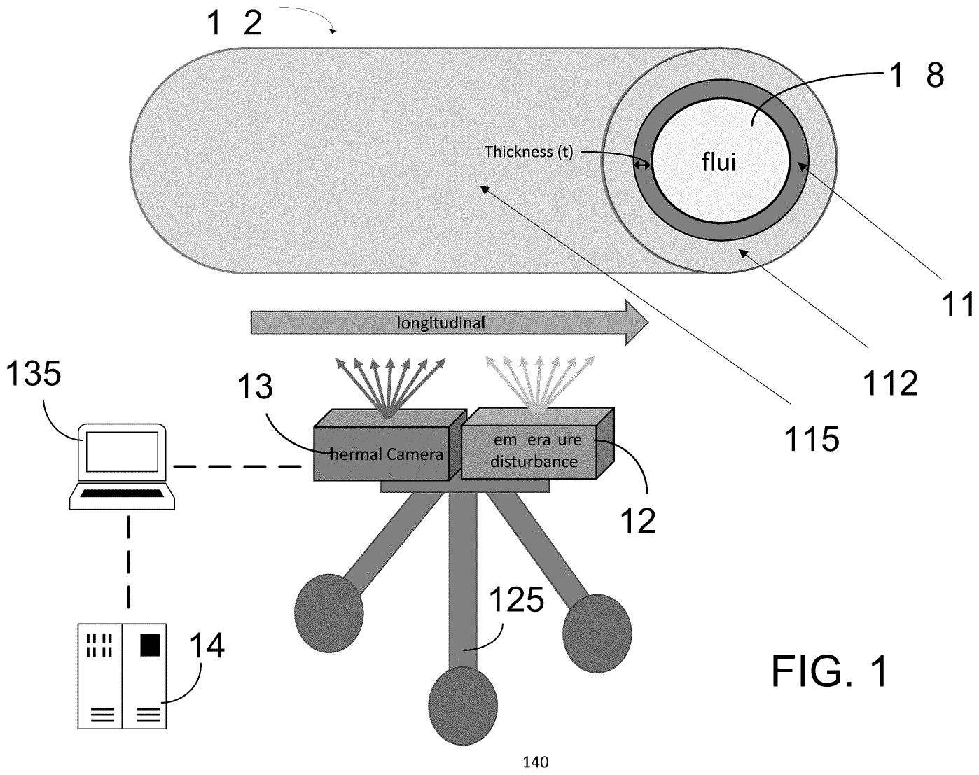

FIG. 1 is a schematic diagram of a system for obtaining contactless thermography measurements to determine corrosion-under installation, and in particular corrosion rate, within a structure according to an embodiment of the present disclosure. As shown in FIG. 1 a longitudinally-extending pipe segment 102 is illustrated with an end cross-section. The end cross-section shows the internal structure of the pipe which includes a hollow inner portion 108 through which fluid, such as water, petroleum or natural gas flows during regular operation. An annular section 110 surrounds the hollow portion 108 and forms the basic structural component of the pipe. The pipe section is typically composed of steel. As noted, the metallic section 110, though initially robust, tends to degrade over time due to the various corrosive and damaging processes discussed above. An annular insulation section 112 surrounds the pipe. The insulation section 112 is intended to protect the pipe surface 110 from direct exposure to moisture and other environmental hazards. The outer surface 115 of the insulation section 112 is the exposed surface of the pipe structure 102.

The system includes components that perform non-destructive testing of the pipe structure 102. A heating/cooling device 120 is installed in the vicinity, for example, e.g., between 2 and 10 feet from the pipe structure. The heating/cooling device 120 is designed to either heat or cool the pipe in order to rapidly disturb the steady state temperature inside the pipe, particularly the pipe surface 110. The heating/cooling device 120 can be implemented in numerous ways including, but not limited to, an electric heater, air conditioner, electric fan, or any other heating/cooling sources. In certain embodiments, the heat/cooling device 120 is mounted on a movable base 125, such as a tripod. In the embodiment depicted, the movable base is intended to move longitudinally along the pipe to expose the pipe to heating or cooling along its length. A thermal camera 130 is also positioned on the movable base 125. The thermal camera 130 is controlled using a local computing device 135 such as a smart phone or laptop to capture thermal images at a certain rate of the pipe structure as the movable base is moved longitudinally across the pipe structure while the pipe structure is being rapidly heated or cooled by the heating/cooling device 120. In this manner multiple thermal images of the pipe structure. The local computing device 135 can be directly coupled by wire (e.g., USB port) to the thermal camera or by a local communication network (e.g., Zigbee, Bluetooth). Thermal images captured by the thermal camera 130 are received by the local computing device 135. At intervals, the operator of the local computer can upload the images and related metadata over a communication network to permanent storage 140, such as cloud storage, a specific database, etc.

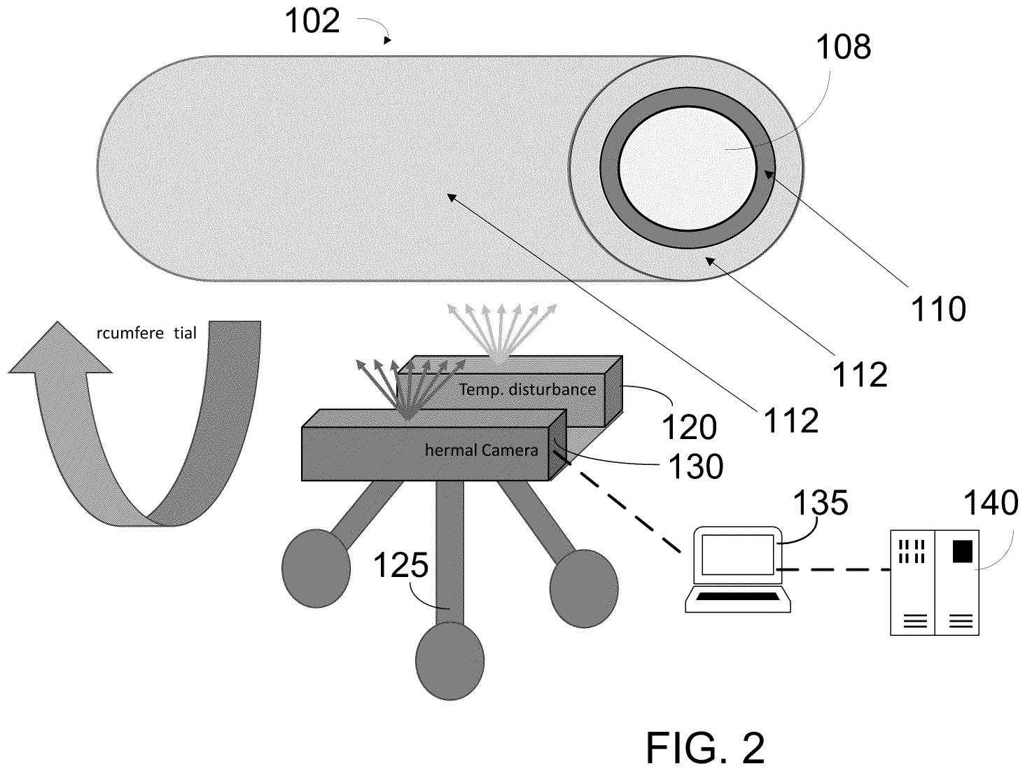

FIG. 2 shows the same system as in FIG. 1 while illustrating an alternative testing procedure in which the heating/cooling device and thermal camera move around the pipe structure circumferentially.

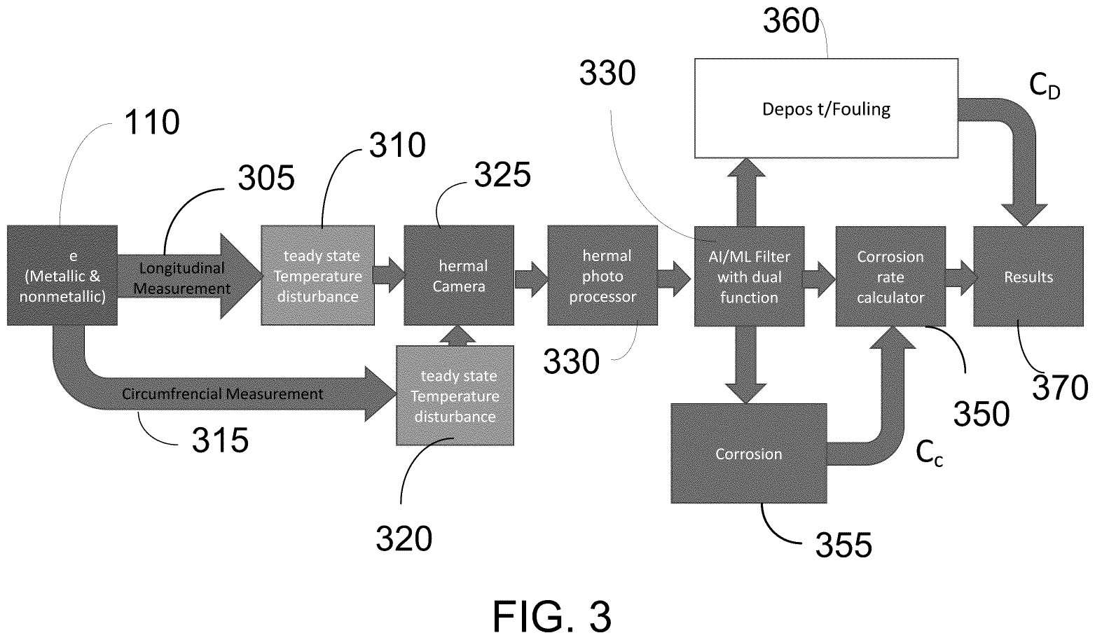

FIG. 3 is a schematic flow diagram of an embodiment of a method of measuring corrosion rate using contactless thermography according to the present disclosure. In the method, the heating/cooling device and thermal camera are moved longitudinally 305 around the pipe 310 and the heating/cooling device 320 is activated to cause a disturbance 310 in the steady state temperature of the pipe by rapid cooling or heating. Sequentially, the heating/cooling device and thermal camera are moved circumferentially 315 around the pipe and the heating/cooling device is also activated to cause a disturbance 320 in the steady state temperature of the pipe by rapid cooling or heating. It will be appreciated that the longitudinal and circumferential movements of the devices can be coordinated so that all of the surface of the pipe is measured. For example, the devices can be moved 0.3 to 0.7 meters longitudinally in each iteration, followed by a full circumferential movement around the pipe, and this procedure can be repeated. Other combinations of longitudinal and circumferential movement can also be used. Additionally, the testing of the pipe is intended to be performed at widely separated times to capture large changes in the state of the pipe. The combination of longitudinal and circumferential movements to cover the entire pipe is performed in each instance.

After the steady state temperature has been disturbed in either step 310 or 320, thermal images of the pipe are captured 325. In flow step 330, a thermal photoprocessor processes the images. The photoprocessor can be part of the thermal camera, in which case the processing is performed by the camera itself, or in other cases the local computing device 135 can receive raw thermal images from the thermal camera and perform part or all of the processing of the thermal images. In either case, the processing of the thermal images yields a temperature value (T) for the various parts of the images.

The processed thermal images are input to multiple machine learning algorithms 340 to determine the presence and effect of corrosion and deposit damage as will be discussed further below. The output of the machine learning algorithms is used to correct the first order calculations of corrosion rate 350 which are based on the temperature values determined by thermal processing of the captured thermal images after disturbance of the steady state temperature.

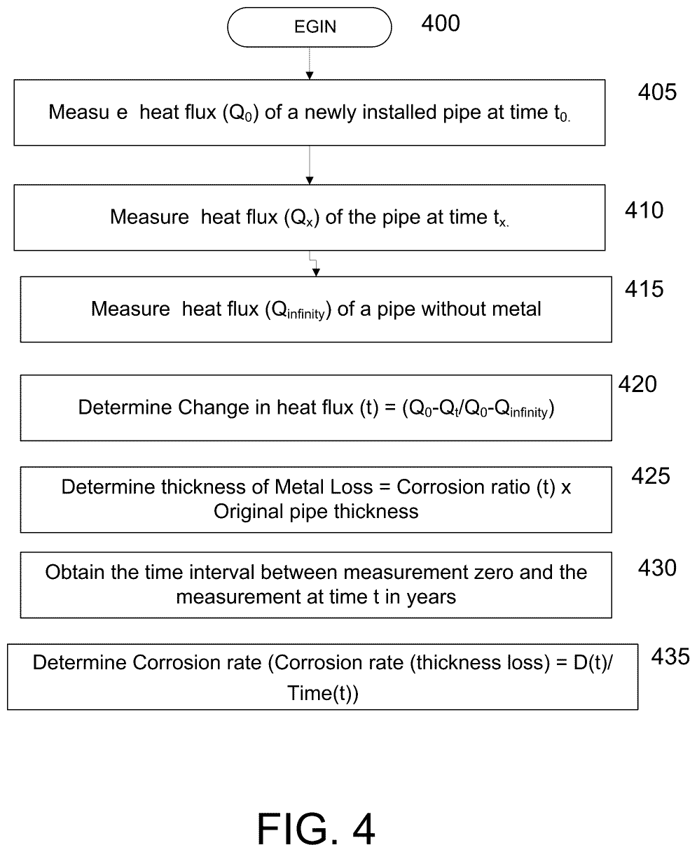

FIG. 4 is a flow chart of a method of determining the corrosion rate (to a first approximation, prior to correction) according to an embodiment of the present disclosure. The method begins in step 400. In step 405, the heat flux (Q₀) of a newly installed pipe, without corrosion, is measured at time t₀. The heat flux is readily determined from the temperature value as determined from thermal images captured at time t₀. At a later time tₓ, when it is expected that the pipe has been corroded to some extent and suffered metal loss, the heat flux (Qₓ) is measured again in the same manner in step 410. Additionally, in step 415, in an experimental setup a pipe structure without metal, i.e., simply an insulating cover, is tested to determine a heat flux at a projected “Q_{infinity}”. This test represents measurement of the heat flux from a fully corroded pipe.

In step 4200, the thermal processor (which could be incorporated in the thermal camera or in the local computer) determines, to a first order of approximation, the corrosion ratio, which is the relative ratio of the corroded metal (i.e., the amount of metal loss), using the change in heat fluxes per time as follows

Change in heat flux (t)=(Q₀−Qₜ/Q₀−Q_{infinity}) (1)

Using the corrosion ratio, in step 425, the amount of metal loss (in terms of thickness) is determined as follows:

D(t)=Corrosion ratio (t)×Original pipe thickness (2)

In a following step 430, the time interval between measurement zero and the measurement at time t in years is obtained. The corrosion rate (rate of thickness loss/year) is determined in step 435.

Corrosion Rate (thickness Loss)=D(t)/time(t) (3)

In equation (3), the thickness loss D(t) is measured in millimeters. Time (t) is the time interval in years between the heat flux measurement of the fully intact pipe and the next measurement when pipe surface attacked by corrosion. The method ends in step 440.

Returning again to the flow diagram of FIG. 3, calculations of process 350 return a first order estimate of metal loss and corrosion rate. The initial output parameters are derived solely from three heat flux measurements Q0, Qt and Q_{infinity}, which can readily be obtained using a thermal camera and a simple apparatus arrangement. This is an efficient way to obtain a first-order approximation of the metal loss. This initial estimation of the metal loss can be reported, stored and used for diagnostic and other purposes, with the proviso that, in many instances, pipes in the field have significant amounts of corrosion and metal deposits formation; this damage can affect the precision of the first-order metal loss estimate by enough to motivate efforts to correct the first-order estimate of metal loss to correct for the presence of corrosion and deposits.

Since both corrosion and deposit formation are complex phenomenon that cannot be easily directly estimated through infrared camera measurements or other non-destructive testing techniques, artificial intelligence and machine learning are applied to decipher the presence and amount of corrosion and deposit formation. Neural networks (NNs) can be trained using large databases of thermal images, TerraHertz (THz) wave reflection maps, and other NDT tests performed on pipe infrastructure in the field over time. In flow step 355, the calculation of corrosion rate is corrected using a factor C_{c} that is determined using a first machine learning algorithm. The total metal loss after application of factor C_{c} is:

C_{c}×D(t) (4)

Similarly, another correction factor C_{d} related to expected metal deposits in the pipe is applied that is determined using a second machine learning algorithm in step 360. The final output 370 for the metal loss becomes:

C_{c}×C_{d}×D(t) (4)

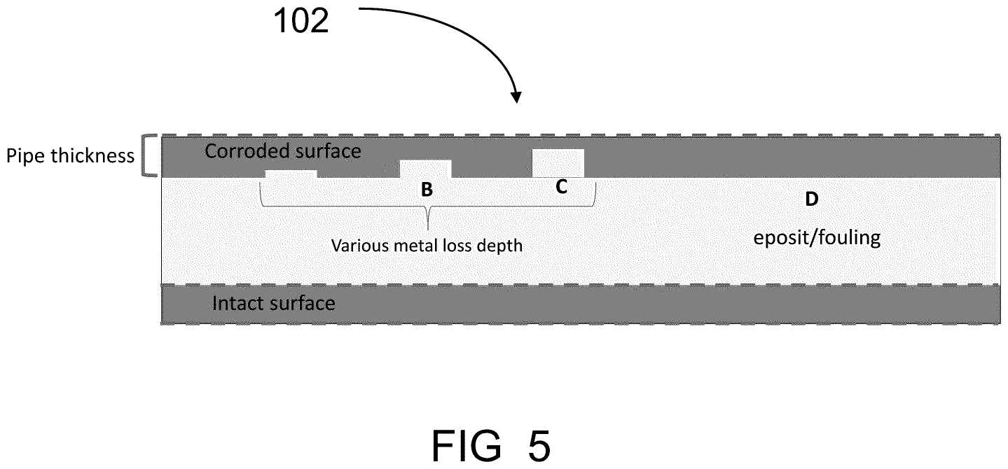

FIG. 5 is a schematic diagram showing the effects of corrosion and deposition on pipe surface. Areas labels A, B and C show areas of excess corrosion that reduce the pipe thickness in these areas compared to adjacent sections which are not affected as much by corrosion process. Conversely, region D shows a metal deposit which can occur when, due to corrosion, corrosion product is extracted from one region of the internal pipe surface and deposited at another area, typically downstream from its original location. Thus, the corrosion factor C_{c} will typically be a coefficient greater than 1, meaning that it increases metal loss and metal loss rate, while correction factor C_{d} will typically be a coefficient less than 1, meaning that it decreases metal loss and metal loss rate.

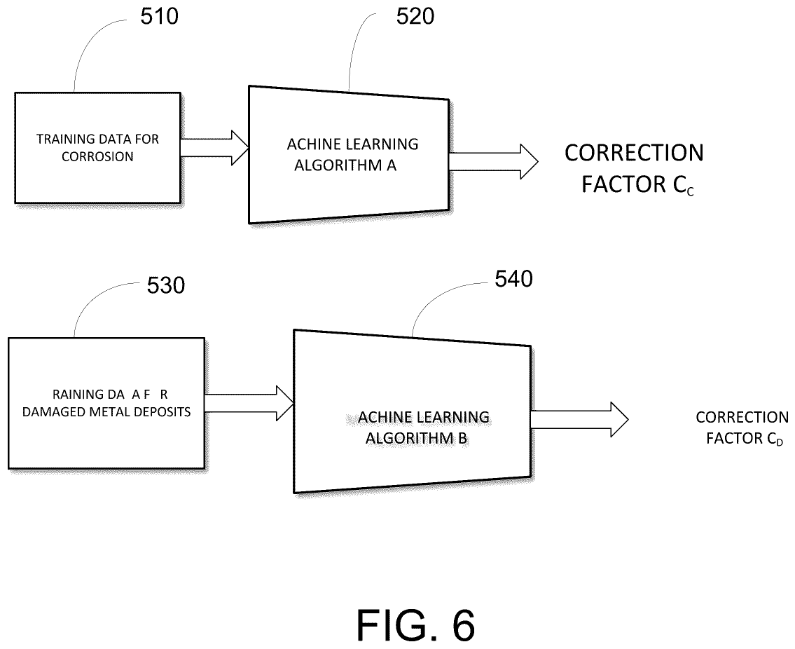

FIG. 6 is a schematic diagram that illustrates how distinct machine learning algorithms can be trained to determine the correction factors. Training data 510 concerning corrosion is used to train a first machine learning algorithm 520 designed to output corrective factor C_{c} as a coefficient (e.g., as a rational number). The training data 510 can include, for example, a labeled thermal image database in which the thermal images are labelled in areas that show the presence of corrosion, with a numerical or nominal label indicating a degree of corrosion. The labelling enables supervised machine learning algorithms to be employed. The degrees of corrosion can be established experimentally from pipes that were taken offline and tested directly for corrosion. The training data can also include data obtained through other detection modes such as TerraHertz (THz) waves as well as specific information such as the age of the pipe, the type of the weather/climate at the pipe location, the type and amount of flow of fluids through the pipe and the condition of the pipe insulation.

Similarly, training data 530 concerning deposition/corrosion product is used to train a second machine learning algorithm 540 designed to output corrective factor C_{d} as a coefficient. The training data 540 can include, a labeled thermal image database in which the thermal images are labelled in areas that show the presence of metal deposition, with a numerical or nominal label indicating a degree of deposition. The labelling enables supervised machine learning algorithms to be employed. The degrees of deposition can be established experimentally from pipes that were taken offline and tested directly for corrosion. The training data can also include data obtained through other detection modes such as TerraHertz (THz) waves as well as specific information such as the age of the pipe, the weather/climate at the pipe location, the type and amount of flow of fluids through the pipe, and the condition of the pipe insulation.

The first and second machine learning algorithms 520, 540, which can be similar or different from each other can be configured as one of a wide range of machine learning algorithms that are used to determine a relative quantity. More specifically machine learning algorithms 520, 540 include algorithms that detect features in visual data and changes in visual data over time. Pertinent algorithms can include a convolutional neural network (CNN) for pattern recognition and aberration identification, and a recurrent neural network (RNN) for pattern detection, identification and prediction in sequences of image frames of an asset. The CNN can include a deep convolutional neural network (DCNN).

Additionally, machine learning algorithms 520, 540 can include an adaptive boosting (e.g., AdaBoost, tensorflow) algorithm that can work in conjunction with the RNN (or CNN) to improve performance. In one example, adaptive boosting can be combined with a Long Short-Term Memory (LSTM) neural network to provide an ensemble neural network. The adaptive boosting algorithm can train a database to provide training samples, the LSTM can predict each training sample separately, and the adaptive boosting algorithm can than integrate the predicted training samples to generate aggregated prediction results for predicting an aberration in an asset under inspection. The adaptive boosting algorithm can be combined with one or more weak learning algorithms, such as, for example, decision trees, for enhanced performance.

In one advantageous embodiment, a CNN is used to hierarchically classify captured thermal image data. This is followed by processing the thermograph data captured over a duration of time using an RNN. In some implementations, a bosting algorithm can be included and used in conjunction with the CNN or RNN in order to achieve higher accuracies. While the boosting algorithm increases the overall number of computations by, and thus increases computational time, the resultant additional accuracy can be a more significant factor where misidentification is costly.

The first and second machine learning algorithms are executed using the current thermal images taken at time (t) to acquire the heat flux as well as other data such as the age of the pipe, the type of insulator used, the flow rate through the pipe, etc. This information, particularly the thermal images, contains information regarding the current state of the pipe structure during operation. The trained algorithms 520, 540 can assess the presence of corrosion and metallic deposits based on this information and determine the coefficients C_{c} and C_{d} for correcting the metal loss estimation determined through heat differences alone.

The system and method of the present disclosure provided both efficiency and accuracy. A first order approximation of metal loss from a pipe can be obtained extremely quickly from thermal image measurements. The first order approximation will be particularly accurate if the level of pipe corrosion and the level of metal deposition is low or moderate and without undue aberrations which can skew results. The corrective factors determined by inputting the thermal images and other data concerning the pipe into the machine learning algorithms described above serve to correct the first order approximation particularly when a given pipe has been subject to levels of corrosion and/or metal deposition that significantly skew the results of the first order approximation. Thereby, the system and method of the present disclosure provide a corrective check on the accuracy of the first order approximation when needed. Once a level of metal loss exceeds a certain “safe” level in a segment of a pipe (or other infrastructure), remediation efforts can be commenced to replace such sections of the infrastructure.

It is to be understood that any structural and functional details disclosed herein are not to be interpreted as limiting the systems and methods, but rather are provided as a representative embodiment and/or arrangement for teaching one skilled in the art one or more ways to implement the methods.

It is to be further understood that like numerals in the drawings represent like elements through the several figures, and that not all components and/or steps described and illustrated with reference to the figures are required for all embodiments or arrangements.

The terminology used herein is for describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to a viewer. Accordingly, no limitations are implied or to be inferred.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

While the present disclosure has been described with reference to exemplary embodiments, it will be understood by those skilled in the art that various changes can be made and equivalents can be substituted for elements thereof without departing from the scope of the disclosure. In addition, many modifications will be appreciated by those skilled in the art to adapt a particular instrument, situation or material to the teachings of the invention without departing from the essential scope thereof. Therefore, it is intended that the disclosure not be limited to the particular embodiment disclosed as the best mode contemplated for carrying out this disclosure, but that inventions consistent with the disclosure will include all embodiments falling within the scope of the appended claims.

What is claimed is:

1. A method of determining corrosion rate in a thickness of a structure having a pipe surrounded by an insulator using contactless thermography, the method comprising:
heating or cooling the structure and capturing a first thermal image of the structure at an initial time when the structure is installed, wherein a first heat flux (Q₀) is derived from the first thermal image;
heating or cooling the structure and capturing a second thermal image of the structure at a time (t) after installation during use of the structure, wherein a second heat flux (Qₜ) is derived from the second thermal image;
heating or cooling the structure and capturing a third thermal image of the structure with the pipe entirely corroded (Q_{infinity}). wherein a third heat flux (Q_{infinity}) is derived from the third thermal image;
determining, to a first order of approximation, a ratio of the metal loss as a ratio of a difference between the first heat flux and the second heat flux to a difference between the first heat flux and the third heat flux (Q₀−Qₜ/Q₀−Q_{infinity}) using a processor configured by code;
training a first machine learning algorithm executing using a second processor configured by code using thermal images and historical data to determine a level of corrosion in a metallic pipe structure;
training a second machine learning algorithm executing using a third processor configured by code using thermal images and historical data to determine a level of deposits in a pipe structure;
executing the first machine learning algorithm to determine a corrective coefficient (C_{c}) based on a detected level of corrosion;
executing the second machine learning algorithm to determine a correction coefficient (C_{d}) based on a detected level of deposits; and
determining a corrected metal loss by applying the corrective coefficients (C_{c}, C_{d}) to the ratio of the metal loss to arrive at a final metal loss estimate.

2. The method of claim 1, further comprising determining a rate of metal loss, to a first order of approximation, based on the ratio of the metal loss (Q₀−Qₜ/Q₀−Q_{infinity}) and the time (t) at which the second thermal image is captured.

3. The method of claim 1, wherein the first machine learning algorithm comprises a convolutional neural network.

4. The method of claim 1, wherein the first machine learning algorithm comprises a convolutional neural network combined with a recurrent neural network.

5. The method of claim 1, wherein the second machine learning algorithm comprises a convolutional neural network.

6. The method of claim 1, wherein the second machine learning algorithm comprises a convolutional neural network combined with a recurrent neural network.

7. A system for determining material loss in a thickness of a structure having a pipe surrounded by an insulator using contactless thermography, the system comprising:
a thermal camera operable to capture thermal images of the structure, wherein the thermal camera captures a first thermal image at time t₀ at which the structure is newly installed, a second image at time tₜ during operation of the structure and a third image when the pipe is entirely corroded (t_{infinity});
a heating or cooling device positioned near the structure to cause local disturbance in a temperature of the structure operable to heat or cool the structure prior to the capture of each of the first, second and third thermal images;
one or more processors coupled to the thermal camera and operable to receive the first, second and third thermal images, wherein the one or more processors is configured by code executing therein to:
determine a first heat flux (Q₀) from the first thermal image, a second heat flux (Qₜ) is from the second thermal image, and a third heat flux (Q_{infinity}). from the third thermal image;
determine, to a first order of approximation, a ratio of the metal loss as a ratio of a difference between the first heat flux and the second heat flux to a difference between the first heat flux and the third heat flux (Q₀−Qₜ/Q₀−Q_{infinity});
execute a first machine learning algorithm trained using thermal images and historical data to determine a level of corrosion in a metallic pipe structure to determine a corrective coefficient (C_{c}) based on a detected level of corrosion;
execute a second machine learning algorithm trained using thermal images and historical data to determine a level of corrosion in a metallic pipe structure to determine a corrective coefficient (C_{d}) based on a detected level of metallic deposition; and
determine a corrected metal loss by applying the corrective coefficients (C_{c}, C_{d}) to the ratio of the metal loss to arrive at a final metal loss estimate.

8. The system of claim 7, wherein the one or more processors is further configured to determine a rate of metal loss, to a first order of approximation, based on the ratio of the metal loss (Q0−Qₜ/Q0−Q_{infinity}) and the time (t) at which the second thermal image is captured.

9. The system of claim 7, wherein the first machine learning algorithm comprises a convolutional neural network.

10. The system of claim 7, wherein the first machine learning algorithm comprises a convolutional neural network combined with a recurrent neural network.

11. The system of claim 7, wherein the second machine learning algorithm comprises a convolutional neural network.

12. The system of claim 7, wherein the second machine learning algorithm comprises a convolutional neural network combined with a recurrent neural network.

13. The system of claim 7, wherein the one or more processors is part of the thermal camera.

14. The system of claim 7, wherein the one or more processors is incorporated in a computing device coupled to the thermal camera.
